(19) United States
(12) Patent Application Publication
(10) Pub. No.: US 2003/0034060 A1
(43) Pub. Date: Feb. 20, 2003

(54) Knee crutch

(76) Inventor: Joel W. Maxey SR., Sarasota, FL (US)

Correspondence Address: Charles J. Prescott, Charles J. Prescott, P.A., Suite 115, 2033 Wood Street, Sarasota, FL, 34237-7926, US

(21) Appl. No.: 09/932,139

(22) Filed: Aug. 17, 2001

(51) Int. Cl. A61H 3/02

(52) U.S. Cl. 135/68; 135/66; 135/72; 482/28; 135/40

(57) ABSTRACT

A knee crutch for use by a user having an ailing hip on one side of the user's body. The device includes a knee engaging member releasably attachable against and spanning and receiving support from the user's knee. The knee engaging member includes a hand hold at an upper end thereof and positioned just above the knee whereby, when the user grips the hand hold and applies downward pressure thereto, a substantial amount of body weight force applied to the user's leg while standing or walking and is transferred away from an ailing hip to the arm and shoulder of the user, thereby substantially reducing body weight force applied to the ailing hip and pain associated therewith.

### BACKGROUND OF THE INVENTION

1. Scope of Invention

This invention relates generally to devices for supporting an impaired person requiring assistance in walking and standing, and more particularly to a knee crutch or hip cane which allows a user who has hip joint distress to transfer body weight force to the shoulder on the same side as that of the ailing hip joint.

2. Prior Art

Prior art teaches a very broad range of assistive devices in the form of crutches and knee or leg braces which are intended to assist an invalid or ailing patient with some aspect of improved leg support or body movement. The following U.S. patents are known to applicant which generally fall into this category of assistive devices:

U.S. Pat. No. 4,793,370 issued to Perez, et al.

U.S. Pat. No. 5,746,236 issued to Tilsley et al.

U.S. Pat. No. 4,291,715 issued to Monte

U.S. Pat. Des. No. 419,288 issued to Hartfield

U.S. Pat. No. 4,141,375 issued to Tykwinski

U.S. Pat. No. 3,074,420 issued to Gottman

U.S. Pat. No. 4,924,894 issued to Martinez

U.S. Pat. No. 5,178,595 issued to MacGregor

U.S. Pat. No. 3,387,305 issued to Shafer

U.S. Pat. No. 5,857,989 issued to Smith, III

U.S. Pat. No. 5,135,469 issued to Castillo

U.S. Pat. No. 4,388,920 issued to Hajost, et al.

U.S. Pat. No. 4,633,867 issued to Kausek, et al.

U.S. Pat. No. 4,838,251 issued to Chignon et al.

U.S. Pat. No. 1,185,906 issued to Hoff

However, with respect of the present invention, all of the above have the shortcoming of either depending upon ground-engaging support for the assistive device or forming a brace or strengthening element to the knee of the ailing patient.

The present invention addresses the need for relieving walking and standing pressure for a user who has an ailing or irritable hip joint, but who can otherwise stand and ambulate without assistance. Those with sciatica and other hip joint distresses find it very difficult to place full body weight on the hip while standing and particularly while walking, but nonetheless are not further physically impaired so as to render the act of walking without an assistive aid out of the question.

By providing a knee crutch which does not substantially immobilize the knee, but which receives support by being attached to the leg just above the knee and guiding or bracing just below the knee, and by providing a hand hold at approximately the height of the user's hanging hand, the user may ambulate and stand while being able to transfer the body weight force which would normally be carried by the ailing hip from the hip to the arm and shoulder on the same side of the user as the ailing hip.

### BRIEF SUMMARY OF THE INVENTION

This invention is directed to a knee crutch for use by a user having an ailing hip on one side or the other of the user's body. The device includes a knee engaging member releasably attachable against and spanning and receiving support from the user's knee. The knee engaging member includes a hand hold at an upper end thereof and positioned just above the knee whereby, when the user grips the hand hold and applies downward pressure thereto, a substantial amount of body weight force is applied to the user's lower leg in proximity to the knee while standing or walking and is transferred away from an ailing hip to the arm and shoulder of the user, thereby substantially reducing body weight force applied to the ailing hip.

It is therefore an object of this invention to provide a device which will facilitate substantially complete ambulation movement and standing by a user who has an ailing hip by transferring most of the body weight force from the ailing hip into the arm and shoulder of the user.

It is another object of this invention to provide a knee crutch which is releasably attachable to the leg of the user and easily wearable without impairment of knee flexure or functioning or other aspects of ambulation which will allow the user to transfer body weight force from an ailing hip into the arm and shoulder so as to assist in the healing of, and pain relief in, the hip joint.

It is still another object of this invention to provide an economical and lightweight knee crutch which allows the user to minimize the amount of body weight being transferred into an ailing hip joint while standing and ambulating.

In accordance with these and other objects which will become apparent hereinafter, the instant invention will now be described with reference to the accompanying drawings.

### BRIEF DESCRIPTION OF THE DRAWINGS

FIG. 1 is a perspective view of a prototype of the invention attached to the leg of a user in use.

FIG. 2 is an enlarged view of FIG. 1 showing the prototype in a slightly rotated position toward the side of the leg of the user.

FIG. 3 is a front elevation view of the preferred embodiment of the invention.

FIG. 4 is a side elevation view of FIG. 3.

FIG. 5 is a top plan view of FIG. 3.

FIG. 6 is a bottom broken plan view of FIG. 3.

### DETAILED DESCRIPTION OF THE INVENTION

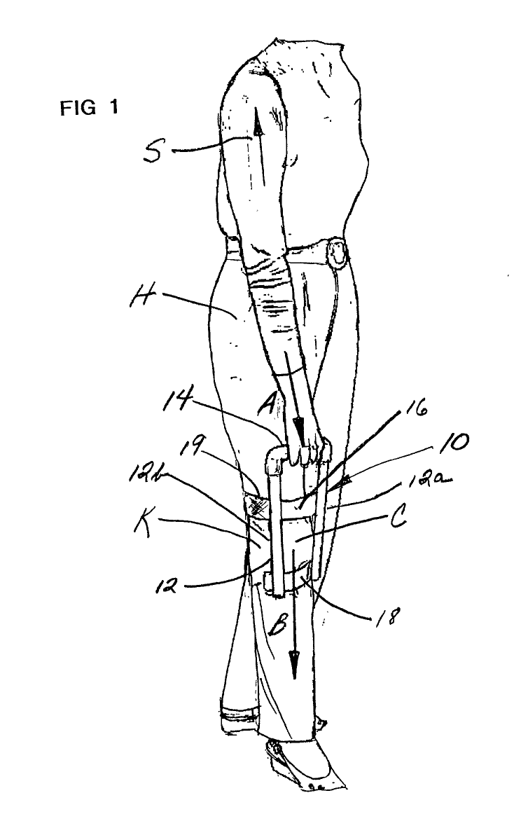

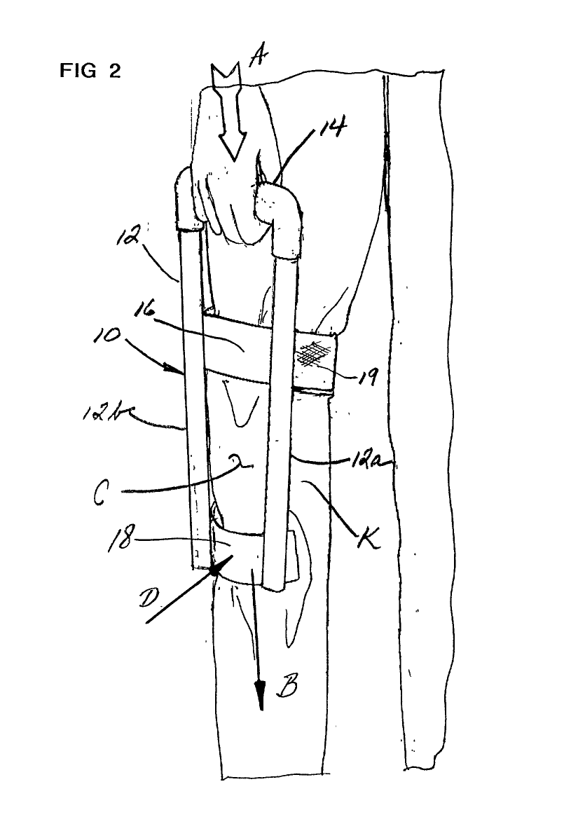

Referring now to the drawings, a prototype version of the invention is shown in FIGS. 1 and 2 generally at numeral 10. Although shown on the right leg, it will fit either right or left leg. This knee brace 10 includes a generally inverted U-shaped tubular frame 12 which is formed of plastic or pvc tubing and includes two elongated upright sides 12a and 12b and a horizontal upper portion 14. This knee crutch 10 also includes spaced apart upper and lower padded leg engaging members or pads 16 and 18, respectively, which are each connected to and span between the legs 12a and 12b by conventional mechanical fasteners such as screws or pop rivets. Knee crutch 10 further includes flexible strap 19 which, in combination with the rigid upper pad 16 encircles and is tightenable around the leg just above the knee K of the user.

When the knee crutch 10 is positioned for use as shown in FIGS. 1 and 2 and the flexible strap 19 is snugly secured around the leg just above the knee K, by grasping and pressing downwardly against the hand grip 14 in the direction of arrow A, the lower pad 18 is urged inwardly against the lower leg in the direction of arrow D so that the body weight force above the knee K, generally equivalent to the amount of force A, is transmitted through the device 10 in the direction of arrow B downwardly to the lower leg and foot of the user. FIG. 2 is included to show that the hop cane can be used toward the side, instead of directly toward the front, if desired, or pain is lessened.

By this arrangement, a substantial portion of body weight force is supported by the shoulder S of the user rather than being carried by the ailing hip H of the user.

Because of the open central structure of the invention 10, the kneecap area C of the knee K is unobstructed so that the knee K can be flexed and moved generally in a normal fashion so as to not encumber normal standing, walking and sitting movements of the user.

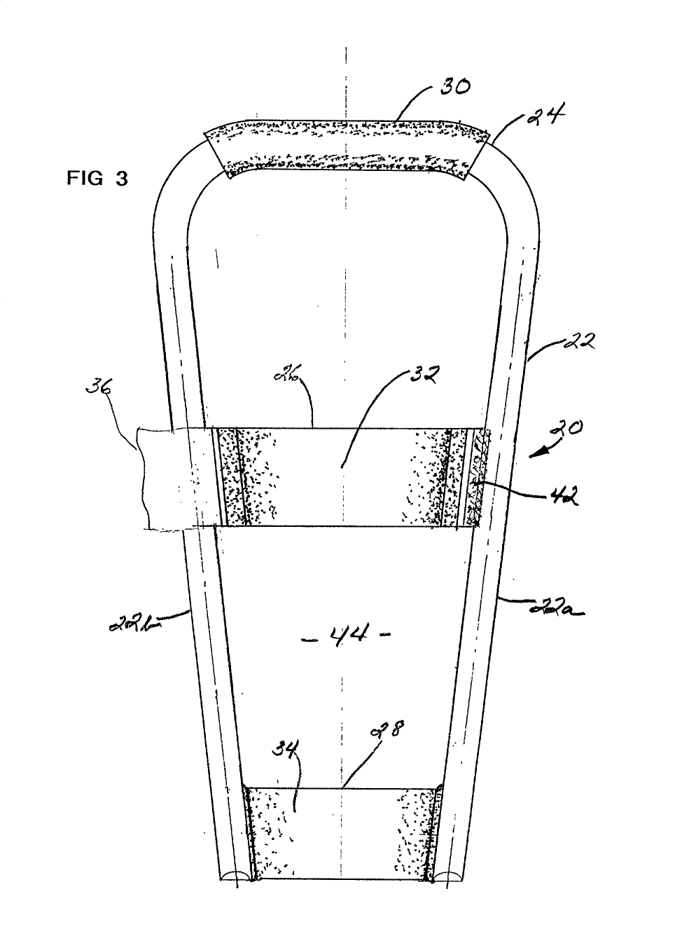

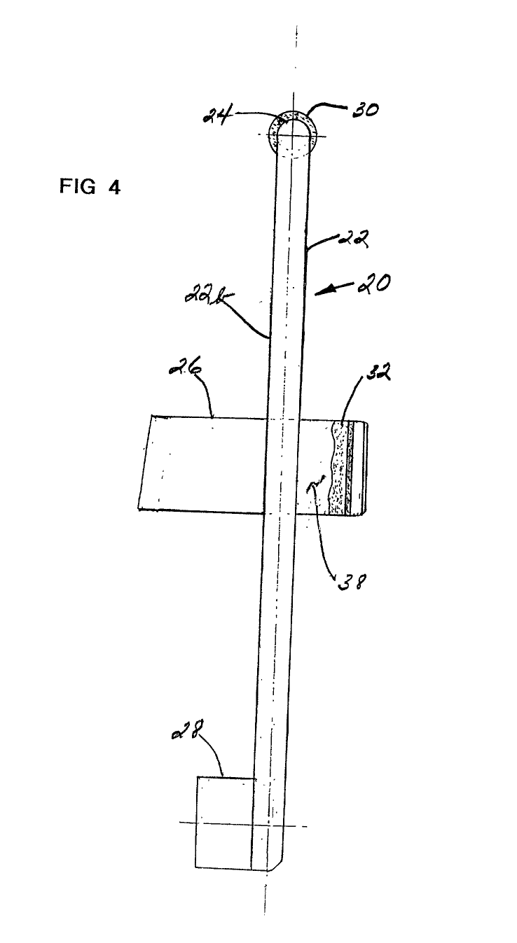

Referring now to FIGS. 3 to 6, the preferred embodiment of the invention is there shown generally at numeral 20 and includes a tubular frame 22 having a generally inverted U-shaped configuration with generally upright sides 22a and 22b and a horizontal upper handgrip portion 24 which can be covered with an elastomeric tubular foam member 30 for added comfort and improved grip.

Spaced apart generally horizontally oriented transverse upper and lower leg pads 26 and 28, respectively, are connected to, and span between, the upright sides 22a and 22b. Again, the connection there is made by conventional mechanical fastening or adhesive means including pop rivets, screws or other equivalent fastening arrangements. For high production manufacture, the entire invention structure could be made in one piece by injection molding with the appropriate parts hardened by radiation treatment. Foam pads 32 and 34 are attached to the inner concave surfaces of the pads 26 and 28, respectively, for added leg comfort.

The central area 44 positioned between the sides 22 and 22b and the upper and lower leg engaging pads 26 and 28, respectively, is provided for alignment with the kneecap or side of the knee at C as in FIGS. 1 and 2 when the device 20 is properly installed against the leg of the user.

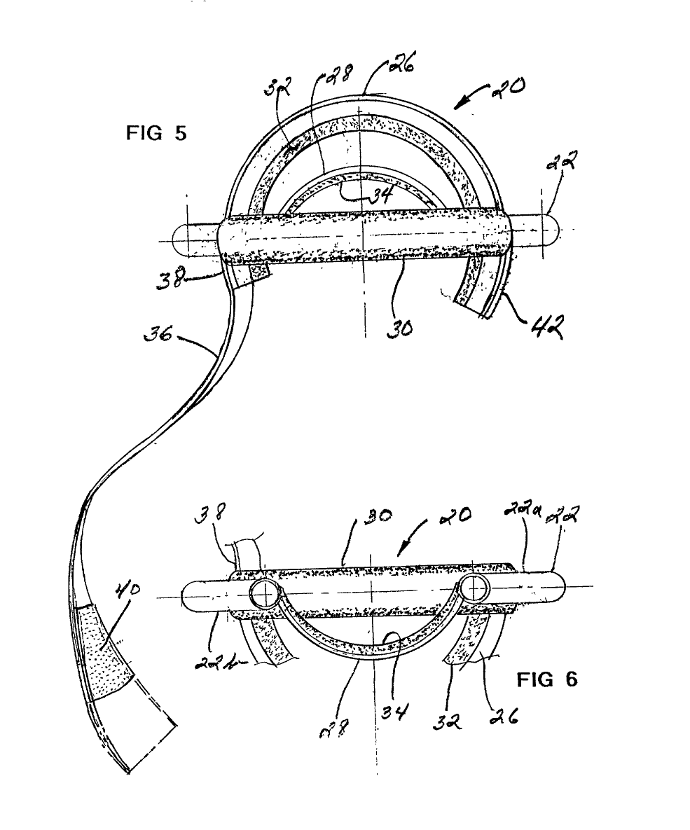

A flexible strap 36 is attached at 38 to one end of the pad 26 and is securable around the leg of the user, in combination with the pad 26, by mating two part hook and loop members 40 and 42, conventional belt and buckle method or other means as best seen in FIG. 5. One portion of the mating two-part material 42 is attached to the rigid outer surface of pad 26.

By this arrangement as previously described in FIGS. 1 and 2, the flexible strap 36 will tightly encircle the leg of the user just above the knee and secure the device 20 in position for use. Pad 28 presses against the leg and does not require an additional flexible connector or strap to maintain the device in its ready-to-use position against the leg which also facilitates free movement of the device 20 with respect to the knee movement when it is in position for use when required.

While the instant invention has been shown and described herein in what are conceived to be the most practical and preferred embodiments, it is recognized that departures may be made therefrom within the scope of the invention, which is therefore not to be limited to the details disclosed herein, but is to be afforded the full scope of the claims so as to embrace any and all equivalent apparatus and articles.

What is claimed is:

1. A knee crutch comprising:
a knee engaging member attachable to a user's leg and just spanning and receiving support from the user's knee;
said knee engaging member including a hand hold positioned just above the knee at an upper end of said knee engaging member whereby, when said hand hold is gripped for downward support by the user, a substantial amount of body weight force applied to a knee of the leg while standing or walking is transferred away from an ailing hip to a shoulder of the user, thereby substantially reducing body weight force applied to the hip.

2. A knee crutch for use by a user with an ailing hip comprising:
a knee engaging member releasably attachable against and spanning and receiving support from a knee on the same side as the user's hip;
said knee-engaging member including spaced apart upper and lower leg engaging pads positionable against the leg in close proximity to just above and just below the knee;
a flexible connecting member attached to said upper pad and configured, in cooperation with said upper pad, to encircle and be adjustable for snug supportive engagement around the leg;
said knee engaging member including a hand hold positioned just above said upper pad at an upper end of said knee engaging member whereby, when said hand hold is gripped and pushed downward for arm support by the user, a substantial amount of body weight force applied to the leg while standing or walking is transferred away from the ailing hip to a shoulder of the user, thereby substantially reducing body weight force applied to the hip.

3. A knee crutch for use by a user with an ailing hip comprising:
a knee engaging member including an elongated perimeter frame and spaced apart generally horizontal upper and lower leg engaging pads, said knee engaging member releasably attachable against and receiving support from, and having a length which just spans a knee on the same side as the user's hip;
said upper and lower leg engaging pads positionable against the leg in close proximity above and below the knee;
a flexible releasable connecting member attached to said upper pad and configured, in cooperation with said upper pad, to encircle and be adjustable for snug supportive engagement around the leg without substantially impairing normal knee movement and flexure;
said knee engaging member including a hand hold positioned just above said upper pad at an upper end of said frame whereby, when said hand hold is gripped and pushed downwardly for arm support by the user, a substantial amount of body weight applied to the leg while standing or walking is transferred away from the ailing hip to a shoulder of the user, thereby substantially reducing body weight force applied to the hip.

4. A knee crutch as set forth in claim 3, wherein:
said frame has a generally inverted U configuration, a top portion thereof forming said hand hold.
